(19) United States
(12) Patent Application Publication
(10) Pub. No.: US 2020/0274905 A1
(43) Pub. Date: Aug. 27, 2020

(54) CONFERENCE SYSTEM, ELECTRONIC APPARATUS, AND CONNECTION METHOD

(71) Applicant: LENOVO (SINGAPORE) PTE. LTD., SINGAPORE (SG)

(72) Inventors: Hironari Nishino, YOKOHAMA (JP); Derek Linville Maynard, YOKOHAMA (JP); Takumi Imai, YOKOHAMA (JP)

(73) Assignee: LENOVO (SINGAPORE) PTE. LTD., SINGAPORE (SG)

(21) Appl. No.: 16/505,998

(22) Filed: Jul. 9, 2019

(30) Foreign Application Priority Data
Feb. 26, 2019 (JP) 2019032749

(51) Int. Cl. H04L 29/06; G06F 3/16

(52) U.S. Cl. CPC H04L 65/1069; H04L 65/403; G06F 3/165; H04L 65/4015

(57) ABSTRACT

A conference system includes: an electronic apparatus configured to output shared information; and a terminal apparatus, wherein the electronic apparatus includes: a sound wave output unit configured to output a sound wave; and an output processing unit configured to convert apparatus identification information for identifying the electronic apparatus into the sound wave, and output the sound wave from the sound wave output unit, and wherein the terminal apparatus includes: a sound collection unit configured to collect the sound wave output from the sound wave output unit; and a connection processing unit configured to extract the apparatus identification information from a sound signal of the sound wave collected by the sound collection unit, and connect the terminal apparatus to the electronic apparatus by wireless communication based on the extracted apparatus identification information.

### FIELD OF THE INVENTION

The present invention relates to a conference system, an electronic apparatus, and a connection method.

### BACKGROUND OF THE INVENTION

A conference system in which information from a terminal apparatus of a participant in a conference is displayed on a common display apparatus to be shared is known in recent years (for example, see Japanese Unexamined Patent Application Publication No. H5-56425).

### SUMMARY OF THE INVENTION

In the conference system mentioned above, however, in the case of connecting each terminal apparatus via a network, the connection needs to be performed by, for example, manually designating the connection destination. Thus, the connection process is complex.

In view of this, the present invention has an object of providing a conference system, an electronic apparatus, and a connection method that ease connection of a terminal apparatus.

To solve the problem stated above, a conference system according to an aspect of the present invention is a conference system including: an electronic apparatus configured to output shared information; and a terminal apparatus, wherein the electronic apparatus includes: a sound wave output unit configured to output a sound wave; and an output processing unit configured to convert apparatus identification information for identifying the electronic apparatus into the sound wave, and output the sound wave from the sound wave output unit, and wherein the terminal apparatus includes: a sound collection unit configured to collect the sound wave output from the sound wave output unit; and a connection processing unit configured to extract the apparatus identification information from a sound signal of the sound wave collected by the sound collection unit, and connect the terminal apparatus to the electronic apparatus by wireless communication based on the extracted apparatus identification information.

The conference system may further include a shared display apparatus configured to display the shared information, and the electronic apparatus may further include: a voice output unit provided independently of the sound wave output unit, and configured to output sound in an audible range including voice; and a conference processing unit configured to output, from the voice output unit, sound based on a sound signal acquired from an other-party apparatus via a network, and transmit information acquired from the terminal apparatus to the other-party apparatus via the network and display the acquired information on the shared display apparatus as the shared information.

In the conference system, the conference processing unit may be configured to perform a filtering process of reducing a frequency region of the sound wave on the sound signal acquired from the other-party apparatus, and output the sound based on the sound signal subjected to the filtering process from the voice output unit.

In the conference system, the electronic apparatus may include a plurality of sound wave output units as the sound wave output unit, and the plurality of sound wave output units may be arranged at positions on a circumference so that the circumference is evenly divided by the plurality of sound wave output units.

In the conference system, the sound wave may be in a range of 18 kHz to 20 kHz which are frequencies not perceived by an ear as sound.

In the conference system, the sound wave output unit may be a flat speaker.

In the conference system, the connection processing unit may be configured to, in the case where the terminal apparatus includes a filter unit configured to remove noise from the sound signal of the sound wave collected by the sound collection unit, stop operation of the filter unit for a predetermined period in which the sound collection unit collects the sound wave.

In the conference system, the electronic apparatus may be configured to change the apparatus identification information, in at least one of the case where the electronic apparatus is started or rebooted and the case where a new conference is started.

In the conference system, the apparatus identification information unique to the electronic apparatus may be generated by a management server configured to manage the electronic apparatus, and the electronic apparatus may be configured to acquire the apparatus identification information from the management server.

An electronic apparatus according to an aspect of the present invention is an electronic apparatus including: a sound wave output unit configured to output a sound wave; and an output processing unit configured to convert apparatus identification information for identifying the electronic apparatus into the sound wave, and output the sound wave from the sound wave output unit, wherein the electronic apparatus is connected with an external apparatus by wireless communication based on the apparatus identification information extracted from a sound signal of the sound wave collected.

A connection method according to an aspect of the present invention is a connection method between an electronic apparatus and an external apparatus, including: a step in which the electronic apparatus converts apparatus identification information for identifying the electronic apparatus into a sound wave, and outputs the sound wave from a sound wave output unit; and a step in which the external apparatus extracts the apparatus identification information from a sound signal of the sound wave collected by a sound collection unit, and connects to the electronic apparatus by wireless communication based on the extracted apparatus identification information.

The above-described aspects of the present invention ease connection of a terminal apparatus.

### BRIEF DESCRIPTION OF THE DRAWINGS

FIG. 1 is a diagram illustrating an example of a structure of a conference system according to an embodiment.

FIG. 2 is a diagram illustrating an example of a main hardware structure of a conference apparatus in the embodiment.

FIG. 3 is a functional block diagram illustrating an example of the conference system according to the embodiment.

FIG. 4 is a perspective diagram illustrating an example of an internal structure of the conference apparatus in the embodiment.

FIG. 5 is a diagram illustrating an example of an arrangement of speakers of the conference apparatus in the embodiment.

FIG. 6 is a diagram illustrating an example of a structure of an audio system in the embodiment.

FIG. 7 is a diagram illustrating an example of operation of the conference system according to the embodiment.

FIG. 8 is a flowchart illustrating an example of operation of a terminal apparatus in the embodiment.

FIG. 9 is a first diagram illustrating a display example in a connection process of the terminal apparatus in the embodiment.

FIG. 10 is a second diagram illustrating a display example in the connection process of the terminal apparatus in the embodiment.

FIG. 11 is a third diagram illustrating a display example in the connection process of the terminal apparatus in the embodiment.

FIG. 12 is a diagram illustrating a display example in information sharing of the conference system according to the embodiment.

### DETAILED DESCRIPTION OF THE INVENTION

A conference system, an electronic apparatus, and a connection method according to an embodiment of the present invention will be described below, with reference to drawings.

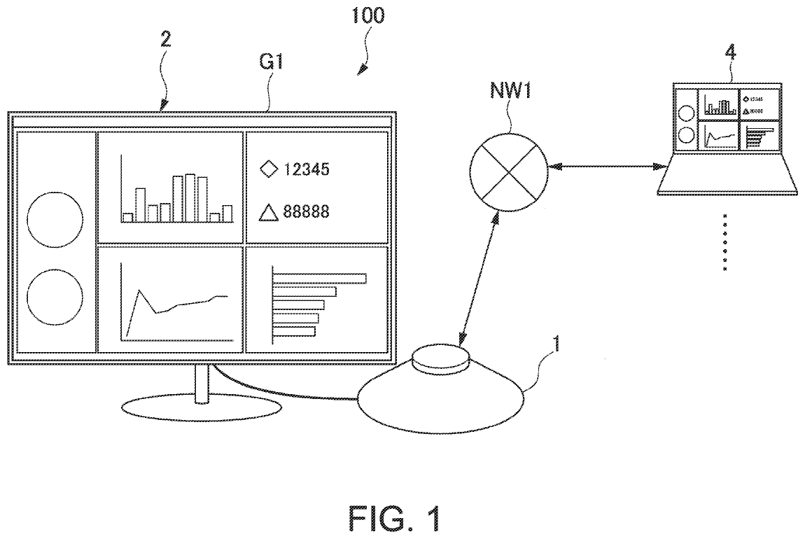

FIG. 1 is a diagram illustrating an example of a structure of a conference system 100 according to this embodiment.

As illustrated in FIG. 1, the conference system 100 includes a conference apparatus 1, a shared display apparatus 2, and a terminal apparatus 4. The conference apparatus 1 and the terminal apparatus 4 are connected via a network NW1.

Although an example in which the conference system 100 includes one terminal apparatus 4 is illustrated in FIG. 1 for the sake of convenience, the conference system 100 may include a plurality of terminal apparatuses 4.

The conference apparatus 1 (an example of an electronic apparatus) is, for example, an apparatus for a conference installed in a conference room, and is connectable to the terminal apparatus 4 via, for example, a wireless local area network (LAN). For example, the conference apparatus 1 is connected to the shared display apparatus 2, and displays shared information (e.g. explanatory materials or presentation materials) used in the conference on the shared display apparatus 2. That is, the conference apparatus 1 outputs shared information acquired from the terminal apparatus 4 via the network NW1, to the shared display apparatus 2. The detailed structure of the conference apparatus 1 will be described later.

The shared display apparatus 2 is, for example, a large-screen display apparatus installed in a conference room, such as a liquid crystal display. The shared display apparatus 2 displays shared information supplied from the conference apparatus 1. For example, the shared display apparatus 2 displays a screen displayed on the terminal apparatus 4 such as a screen G1, as shared information.

The terminal apparatus 4 is, for example, a mobile terminal such as a laptop personal computer (PC). In the conference, the terminal apparatus 4 is used by a user to display shared information such as explanatory materials on the terminal apparatus 4, and also transmits the shared information to the conference apparatus 1 for sharing.

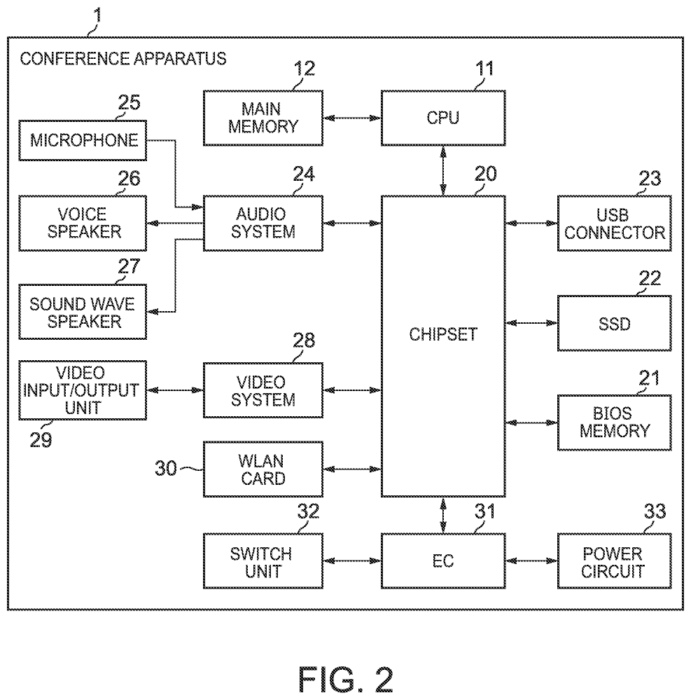

A main hardware structure of the conference apparatus 1 will be described below, with reference to FIG. 2.

FIG. 2 is a diagram illustrating an example of the main hardware structure of the conference apparatus 1 in this embodiment.

As illustrated in FIG. 2, the conference apparatus 1 includes, as its main hardware structure, a CPU 11, a main memory 12, a chipset 20, a BIOS memory 21, an SSD 22, a USB connector 23, an audio system 24, a microphone 25, a voice speaker 26, a sound wave speaker 27, a video system 28, a video input/output unit 29, a WLAN card 30, an EC 31, a switch unit 32, and a power circuit 33.

The CPU (Central Processing Unit) 11 performs various arithmetic processing by program control, and controls the overall conference apparatus 1.

The main memory 12 is a writable memory used as an area for reading execution programs of the CPU 11 or a work area for writing processed data of the execution programs. For example, the main memory 12 is made up of a plurality of dynamic random access memory (DRAM) chips. The execution programs include an OS, various device drivers for hardware-operating peripheral apparatuses, various services/utilities, and application programs (hereafter referred to as applications).

The chipset 20 includes controllers such as USB (Universal Serial Bus), Serial ATA (AT Attachment), SPI (Serial Peripheral Interface) bus, PCI (Peripheral Component Interconnect) bus, PCI-Express bus, and LPC (Low Pin Count) bus, and connected to a plurality of devices. In FIG. 2, devices such as the BIOS memory 21, the SSD 22, the USB connector 23, the audio system 24, the video system 28, the WLAN card 30, and the EC 31 are connected to the chipset 20.

The BIOS (Basic Input/Output System) memory 21 is, for example, composed of an electrically rewritable non-volatile memory such as electrically erasable programmable read only memory (EEPROM) or flash ROM. The BIOS memory 21 stores the BIOS, system firmware for controlling the EC 31, etc., and the like.

The SSD (Solid State Drive) 22 stores an OS, various device drivers, various services/utilities, applications, and various data. For example, the SSD 22 stores Windows®10 as an OS. The SSD 22 is also installed with Skype® for Business, Zoom®, or the like, as application software of the conference system 100.

The USB connector 23 (an example of an external interface unit) is a connector for connecting peripheral apparatuses using USB. Examples of the peripheral apparatuses connected to the USB connector 23 include a keyboard, a mouse, and a USB camera.

The audio system 24 records, reproduces, and outputs sound data. For example, the audio system 24 acquires sound data from the connected microphone 25, and outputs the sound data to the chipset 20. The audio system 24 also outputs, for example, a sound signal in an audible range including voice output from the chipset 20, to the connected voice speaker 26. The audio system 24 also outputs a sound signal output from the chipset 20, to the connected sound wave speaker 27.

The microphone 25 collects the user's voice in the conference system 100, and outputs the voice to the chipset 20 via the audio system 24.

The voice speaker 26 (an example of a voice output unit) is, for example, a cone-type speaker, and mainly outputs sound in an audible range including the user's voice.

The sound wave speaker 27 (an example of a sound wave output unit) is, for example, a flat speaker, and outputs a sound wave obtained by converting a personal identification number (PIN) described later. In this embodiment, “sound wave” is a concept including “audible sound” and “inaudible sound (ultrasound)”. Of these, sound that is in an audible range of 18 kHz (kilohertz) to 20 kHz as frequencies not perceived by the ear as sound and for which a typical microphone and speaker for an audible range can be used is particularly preferable.

The video system 28 is a system for implementing a function relating to image display, and includes a video controller. The video controller processes a rendering instruction from the CPU 11, and writes the processed rendering information to a video memory. The video controller also reads the rendering information from the video memory, and outputs it via the video input/output unit 29 as display data. The video system 28 further acquires external display data via the video input/output unit 29.

The video input/output unit 29 is, for example, a display port for external input and external output of HDMI® (High-Definition Multimedia Interface) or the like. The video input/output unit 29 is used in the case of acquiring external display data and in the case of displaying display data on an external monitor or the like. In this embodiment, the shared display apparatus 2 is connected to the video input/output unit 29 as an external monitor.

The WLAN (Wireless Local Area Network) card 30 connects to the network NW1 via a wireless LAN, to perform data communication. For example, the WLAN card 30 performs data communication with each apparatus (e.g. the terminal apparatus 4, the below-described other-party apparatus 5 and management server 6, etc.) via the network NW1.

The EC (embedded controller) 31 is a one-chip microcomputer that monitors and controls each device (peripheral apparatuses, sensors, etc.) regardless of the system state of the conference apparatus 1. The EC 31 also has a power management function of controlling the power circuit 33. The EC 31 is composed of a CPU, a ROM, a RAM, and the like (not illustrated), and includes A/D input terminals, D/A output terminals, timers, and digital input and output terminals of a plurality of channels. The EC 31 is connected to the switch unit 32, the power circuit 33, and the like via these input and output terminals, and controls their operations.

The switch unit 32 includes, for example, various control switches such as a power switch and a reset switch.

The power circuit 33 includes, for example, a DC/DC converter, a charge/discharge unit, a battery unit, an AC/DC adapter, and the like, and converts a DC voltage supplied from the AC/DC adapter or the battery unit into a plurality of voltages necessary to operate the conference apparatus 1. The power circuit 33 supplies power to each unit in the conference apparatus 1, based on control by the EC 31. In a power-down mode (low power mode) such as sleep mode, the power circuit 33 partially stops power supply depending on the mode.

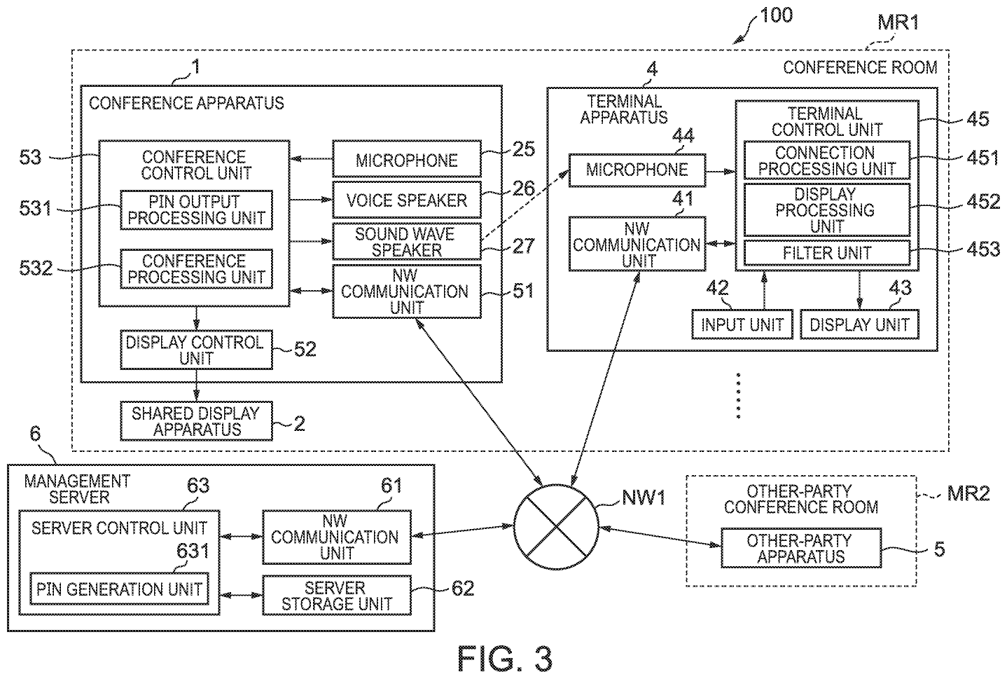

The detailed structure of the conference system 100 according to this embodiment will be described below, with reference to FIG. 3.

FIG. 3 is a functional block diagram illustrating an example of the conference system 100 according to this embodiment.

As illustrated in FIG. 3, the conference system 100 includes the conference apparatus 1, the terminal apparatus 4, the other-party apparatus 5, and the management server 6. The conference apparatus 1, the terminal apparatus 4, the other-party apparatus 5, and the management server 6 are connectable to each other via the network NW1.

In the drawing, the conference apparatus 1 and the terminal apparatus 4 are in a conference room MR1 together with the user.

The other-party apparatus 5 is an apparatus of another party that attends the conference using the conference system 100, and is, for example, a terminal apparatus such as a laptop PC. The other-party apparatus 5 is, for example, in another-party conference room MR2 which is a conference room of the other party.

The management server 6 is a server apparatus that performs various management for the conference apparatus 1. For example, the management server 6 manages the conference apparatus 1, and generates a PIN and provides the PIN to the conference apparatus 1. For example, in response to a request from each conference apparatus 1, the management server 6 generates a PIN (an example of apparatus identification information) unique to the conference apparatus 1, and transmits the generated PIN to the conference apparatus 1 via the network NW1. The PIN is apparatus identification information for identifying the conference apparatus 1, and is a character string of a predetermined length, for example. The management server 6 also manages a schedule of conferences using the conference system 100 and the like.

Although one conference apparatus 1 is connected via the network NW1 in the example in FIG. 3, the management server 6 manages a plurality of conference apparatuses 1.

The management server 6 includes a NW (network) communication unit 61, a server storage unit 62, and a server control unit 63.

The NW communication unit 61 connects to the network NW1 by wired communication as an example, and performs various communication via the network NW1. The NW communication unit 61 mainly communicates with the conference apparatus 1 via the network NW1.

The server storage unit 62 stores various data used by the management server 6. The server storage unit 62 stores management data for the conference apparatus 1, conference schedule information, generated PINs, etc.

The server control unit 63 is, for example, a control unit implemented by a CPU and memory (not illustrated), and integrally controls the management server 6. The server control unit 63 performs a management process for the conference apparatus 1, a conference schedule management process, etc. The server control unit 63 includes a PIN generation unit 631.

The PIN generation unit 631 generates a PIN corresponding to the conference apparatus 1. In response to a PIN generation request from the conference apparatus 1 via the NW communication unit 61, the PIN generation unit 631 generates the PIN corresponding to the conference apparatus 1, and stores the generated PIN in the server storage unit 62. The PIN generation unit 631 also transmits, as a meeting ID, the generated PIN to the conference apparatus 1 that has transmitted the PIN generation request, via the NW communication unit 61.

The conference apparatus 1 includes, for example, the microphone 25, the voice speaker 26, the sound wave speaker 27, a NW communication unit 51, a display control unit 52, and a conference control unit 53.

The NW communication unit 51, the display control unit 52, and the conference control unit 53 are functional units implemented by the above-described hardware structure illustrated in FIG. 2.

The NW communication unit 51 is a functional unit implemented by, for example, the WLAN card 30, the CPU 11, the main memory 12, the chipset 20, and device drivers stored in the SSD 22. The NW communication unit 51 connects to the network NW1 using wireless LAN communication as an example, and performs various communication wirelessly via the network NW1.

The display control unit 52 is a functional unit implemented by, for example, the video system 28, the CPU 11, the main memory 12, the chipset 20, and device drivers stored in the SSD 22. The display control unit 52 controls the display of the shared display apparatus 2 connected to the conference apparatus 1 via the video input/output unit 29, and, for example, displays shared information on the shared display apparatus 2.

The conference control unit 53 is a functional unit implemented by, for example, the CPU 11, the main memory 12, and a conference application (program) stored in the SSD 22. The conference control unit 53 performs various processes for the conference by the conference system 100. The conference control unit 53 includes a PIN output processing unit 531 and a conference processing unit 532.

The PIN output processing unit 531 (an example of an output processing unit) converts the PIN for identifying the conference apparatus 1 into a sound wave, and outputs the sound wave from the sound wave speaker 27. For example, the PIN output processing unit 531 requests the management server 6 via the NW communication unit 51 to generate the PIN corresponding to the conference apparatus 1 (i.e. transmits a PIN generation request), and acquires the PIN generated by the management server 6. The PIN output processing unit 531 converts the acquired PIN into a sound wave by, for example, FM modulation (frequency modulation), and outputs the sound wave from the sound wave speaker 27.

The conference processing unit 532 performs a process for the conference by the conference system 100. The conference processing unit 532 outputs sound based on a sound signal acquired from the other-party apparatus 5 via the network NW1, from the voice speaker 26. In detail, in the conference between the conference room MR1 and the other-party conference room MR2, the conference processing unit 532 acquires voice of a user in the other-party conference room MR2 via the other-party apparatus 5 and the NW communication unit 51 as a sound signal, and outputs sound based on the sound signal from the voice speaker 26.

The conference processing unit 532 also transmits information acquired from the terminal apparatus 4 to the other-party apparatus 5 via the network NW1, and displays the acquired information on the shared display apparatus 2 as shared information. The conference processing unit 532 causes the display control unit 52 to display the shared information on the shared display apparatus 2.

The conference processing unit 532 also transmits voice (e.g. sound in the conference room MR1) of the conference collected by the microphone 25, to the other-party apparatus 5 via the network NW1.

Moreover, the conference processing unit 532 displays shared information transmitted from the other-party apparatus 5 via the network NW1, on the shared display apparatus 2. The conference processing unit 532 outputs sound based on a sound signal (e.g. sound signal in the other-party conference room MR2) transmitted from the other-party apparatus 5 via the network NW1, from the voice speaker 26.

The terminal apparatus 4 includes a NW communication unit 41, an input unit 42, a display unit 43, a microphone 44, and a terminal control unit 45.

The NW communication unit 41 connects to the network NW1 using wireless LAN communication as an example, and performs various communication wirelessly via the network NW1. The NW communication unit 41 mainly communicates with the conference apparatus 1 via the network NW1.

The input unit 42 is, for example, an input device such as a keyboard, a touch panel, and a mouse, and receives various information (e.g. operation information, input information) from the user.

The display unit 43 is, for example, a display device such as a liquid crystal display, and displays various information. The display unit 43 displays, for example, shared information such as conference materials.

The microphone 44 (an example of a sound collection unit) collects a sound wave output from the sound wave speaker 27. Since the sound wave herein is sound in an audible range of 18 kHz to 20 kHz as mentioned above, a microphone for collecting sound in an audible range can be used as the microphone 44.

The terminal control unit 45 is, for example, a control unit implemented by a CPU and memory (not illustrated), and integrally controls the terminal apparatus 4. The terminal control unit 45 includes a connection processing unit 451, a display processing unit 452, and a filter unit 453.

The connection processing unit 451 extracts a PIN from a sound signal of a sound wave collected by the microphone 44, and connects the terminal apparatus 4 to the conference apparatus 1 by wireless communication based on the extracted PIN. In detail, the connection processing unit 451 acquires the sound signal of the sound wave obtained by converting the PIN, which is output from the sound wave speaker 27 in the conference apparatus 1 and collected by the microphone 44, and extracts the PIN included in the sound signal. The connection processing unit 451 connects to the conference apparatus 1 in the conference room MR1 by wireless LAN communication via the NW communication unit 41, using the extracted PIN.

The display processing unit 452 performs control to display various information on the display unit 43. In the case where the conference is being performed by the conference system 100 and the conference apparatus 1 and the terminal apparatus 4 are being connected to each other, the display processing unit 452 displays shared information such as conference materials on the display unit 43, and also outputs the shared information to the conference apparatus 1 via the NW communication unit 41 to display the shared information on the shared display apparatus 2.

The filter unit 453 performs a filtering process of removing noise from a sound signal collected by the microphone 44. The filtering function of the filter unit 453 can be stopped or activated under control of the connection processing unit 451.

In the case where the terminal apparatus 4 includes the filter unit 453 for removing noise from a sound signal of a sound wave collected by the microphone 44, the connection processing unit 451 stops the operation of the filter unit 453 for a predetermined period (e.g. 20 seconds) in which the microphone 44 collects the sound wave.

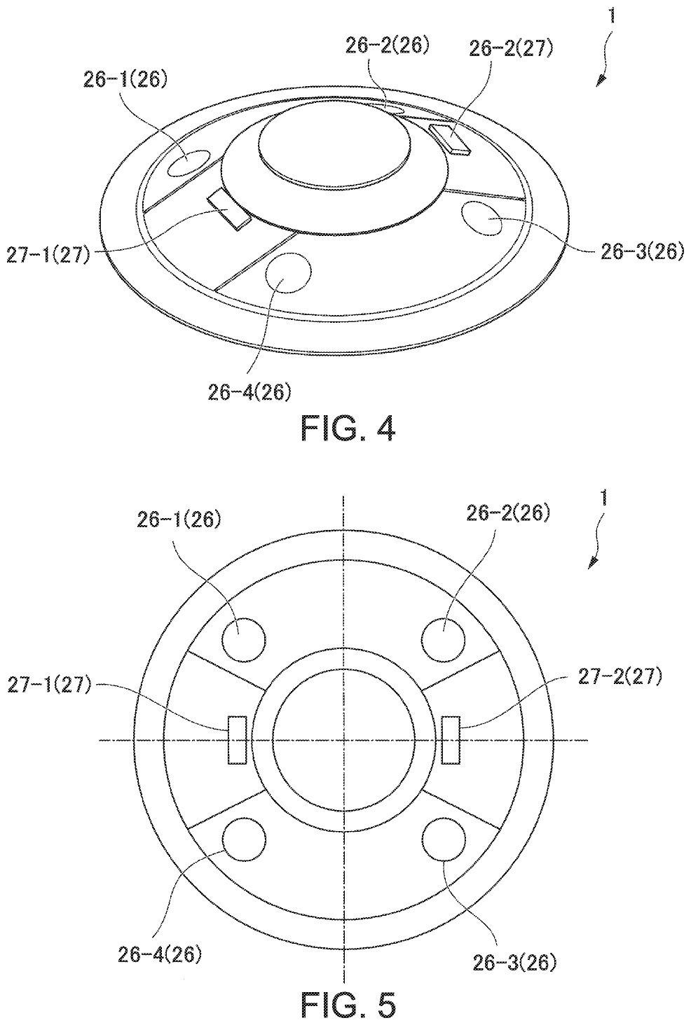

An arrangement of the voice speaker 26 and the sound wave speaker 27 in the conference apparatus 1 will be described below, with reference to FIGS. 4 and 5.

FIG. 4 is a perspective diagram illustrating an example of the internal structure of the conference apparatus 1 in this embodiment. FIG. 5 is a diagram illustrating an example of the arrangement of speakers in the conference apparatus 1 in this embodiment.

In the example illustrated in FIGS. 4 and 5, the conference apparatus 1 includes four voice speakers 26 (26-1, 26-2, 26-3, and 26-4) and two sound wave speakers 27 (27-1 and 27-2).

As illustrated in FIGS. 4 and 5, the conference apparatus 1 includes four voice speakers 26 and two sound wave speakers 27. The voice speakers 26 are arranged concentrically, and divided between a pair of voice speakers 26-1 and 26-2 and a pair of voice speakers 26-3 and 26-4. The pairs are arranged symmetrically with reference to the center point of the circular conference apparatus 1.

As illustrated in FIGS. 4 and 5, the two sound wave speakers 27 are arranged symmetrically with reference to the center point of the circular conference apparatus 1, apart from each other by 180 degrees. In detail, the plurality of (e.g. two) sound wave speakers 27 are arranged at positions on the circumference so that the circumference is evenly divided into a plurality of (e.g. two) segments (e.g. 180 degrees). The sound wave speakers 27 are located at a higher position than the voice speakers 26.

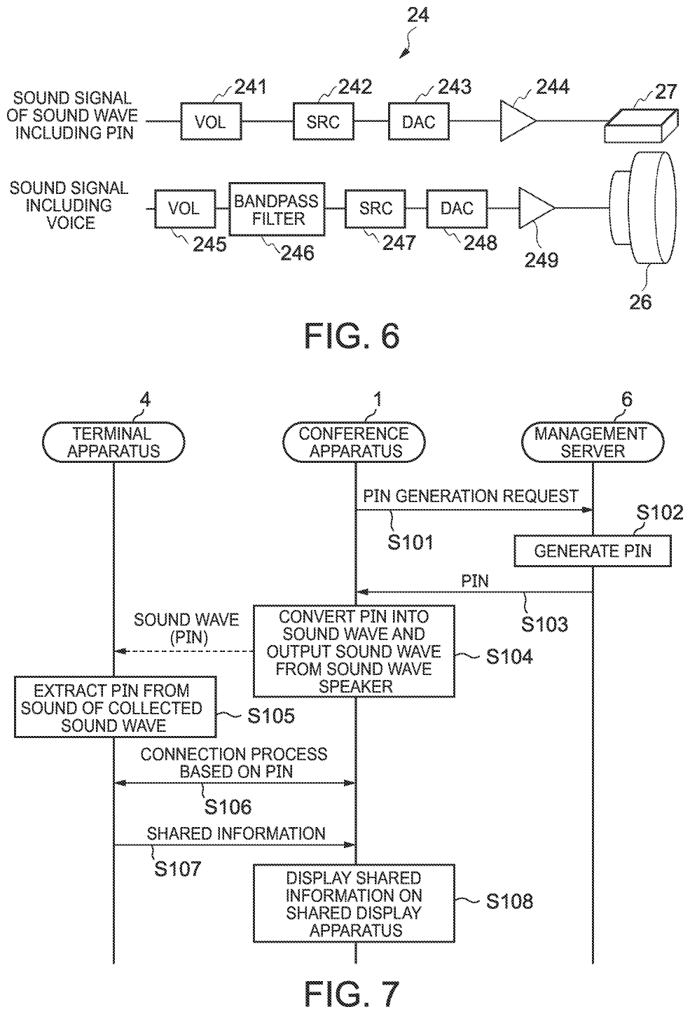

The structure of the audio system 24 in the conference apparatus 1 according to this embodiment will be described below, with reference to FIG. 6.

FIG. 6 is a diagram illustrating an example of the structure of the audio system 24 in this embodiment.

As illustrated in FIG. 6, an output system of the sound wave speaker 27 in the audio system 24 includes a VOL (VOLume) 241, an SRC (Sample Rate Converter) 242, a DAC (Digital to Analog Converter) 243, and a speaker amplifier 244.

The VOL 241 adjusts the volume of a sound signal of a sound wave. The SRC 242 converts the sample rate of the sound signal of the sound wave according to the downstream DAC 243. The DAC 243 converts the sound signal of the sound wave into an analog signal. The speaker amplifier 244 amplifies the analog signal, and outputs the amplified analog signal to the sound wave speaker 27. The sound wave speaker 27 converts the amplified analog signal output from the speaker amplifier 244 into sound, and outputs the sound wave. The output system of the sound wave speaker 27 does not include any function for acoustic effect (effect function) such as a filter.

An output system of the voice speaker 26 in the audio system 24 includes a VOL 245, a band pass filter 246, an SRC 247, a DAC 248, and a speaker amplifier 249. The VOL 245, the SRC 247, the DAC 248, and the speaker amplifier 249 are the same as the above-described VOL 241, SRC 242, DAC 243, and speaker amplifier 244. The output system of the voice speaker 26 differs from the output system of the sound wave speaker 27 in that the band pass filter 246 is included.

The band pass filter 246 performs a filtering process of reducing mainly a frequency region other than human voice frequencies in the sound signal. The band pass filter 246 performs, for example, a filtering process of allowing a sound signal in a frequency range of 300 Hz to 8 kHz to pass through and reducing the level of a sound signal outside this frequency range. The frequency region subjected to sound signal level reduction includes the frequency region of the sound wave including the PIN output from the sound wave speaker 27. In detail, the conference processing unit 532 performs a filtering process of reducing the frequency region of the sound wave on the sound signal acquired from the other-party apparatus 5 using the band pass filter 246, and outputs the resultant sound from the voice speaker 26.

Operation of the conference system 100 according to this embodiment will be described below, with reference to drawings.

FIG. 7 is a diagram illustrating an example of operation of the conference system 100 according to this embodiment. Operation in which the terminal apparatus 4 connects to the conference apparatus 1 and displays shared information on the shared display apparatus 2 in the conference system 100 will be described below. In the drawing, the terminal apparatus 4 and the conference apparatus 1 are assumed to be used in the same conference room (e.g. the conference room MR1).

As illustrated in FIG. 7, first, the conference apparatus 1 transmits a PIN generation request to the management server 6 (step S101). In detail, the PIN output processing unit 531 in the conference apparatus 1 transmits a request (PIN generation request) to generate the PIN corresponding to the conference apparatus 1, to the management server 6 via the NW communication unit 51 as an example. The PIN output processing unit 531 transmits the PIN generation request to the management server 6, in any of the case where the conference apparatus 1 is started or rebooted and the case where a new conference is started.

Following this, the management server 6 generates the PIN (step S102). The PIN generation unit 63 in the management server 6 generates the PIN corresponding to the conference apparatus 1 in response to the PIN generation request from the conference apparatus 1 via the NW communication unit 61, and stores the generated PIN in the server storage unit 62. Here, the PIN generation unit 631 generates the PIN so that the PINs of the plurality of conference apparatuses 1 managed by the management server 6 do not overlap each other.

The management server 6 then transmits the PIN to the conference apparatus 1 (step S103). In detail, the PIN generation unit 631 transmits the generated PIN to the conference apparatus 1 via the NW communication unit 61.

Next, the conference apparatus 1 converts the PIN into a sound wave, and outputs the sound wave from the sound wave speaker 27 (step S104). The PIN output processing unit 531 acquires the PIN from the management server 6 via the NW communication unit 51, converts the acquired PIN into a sound wave by FM modulation (frequency modulation) as an example, and outputs the sound wave from the sound wave speaker 27.

Next, the terminal apparatus 4 extracts the PIN from the collected sound wave (step S105). The connection processing unit 451 in the terminal apparatus 4 acquires the sound signal of the sound wave output from the sound wave speaker 27 in the conference apparatus 1 and collected by the microphone 44, and extracts the PIN from the sound signal. The connection processing unit 451 extracts the PIN by demodulating the sound signal of the sound wave which has been frequency modulated.

The terminal apparatus 4 then performs a connection process with the conference apparatus 1 based on the PIN (step S106). The connection processing unit 451 connects the terminal apparatus 4 to the conference apparatus 1 by wireless communication, based on the extracted PIN. In detail, the connection processing unit 451 connects to the conference apparatus 1 in the conference room MR1 by wireless LAN communication via the NW communication unit 41, using the extracted PIN.

Next, the terminal apparatus 4 transmits shared information to the conference apparatus 1 (step S107). In detail, the display processing unit 452 in the terminal apparatus 4 displays the shared information such as conference materials on the display unit 43 of the terminal apparatus 4, and also transmits the shared information to the conference apparatus 1 via the NW communication unit 41.

Following this, the conference apparatus 1 displays the shared information on the shared display apparatus 2 (step S108). In detail, the conference processing unit 532 in the conference apparatus 1 causes the display control unit 52 to output the shared information received from the terminal apparatus 4 via the NW communication unit 51 to the shared display apparatus 2, to display the shared information on the shared display apparatus 2.

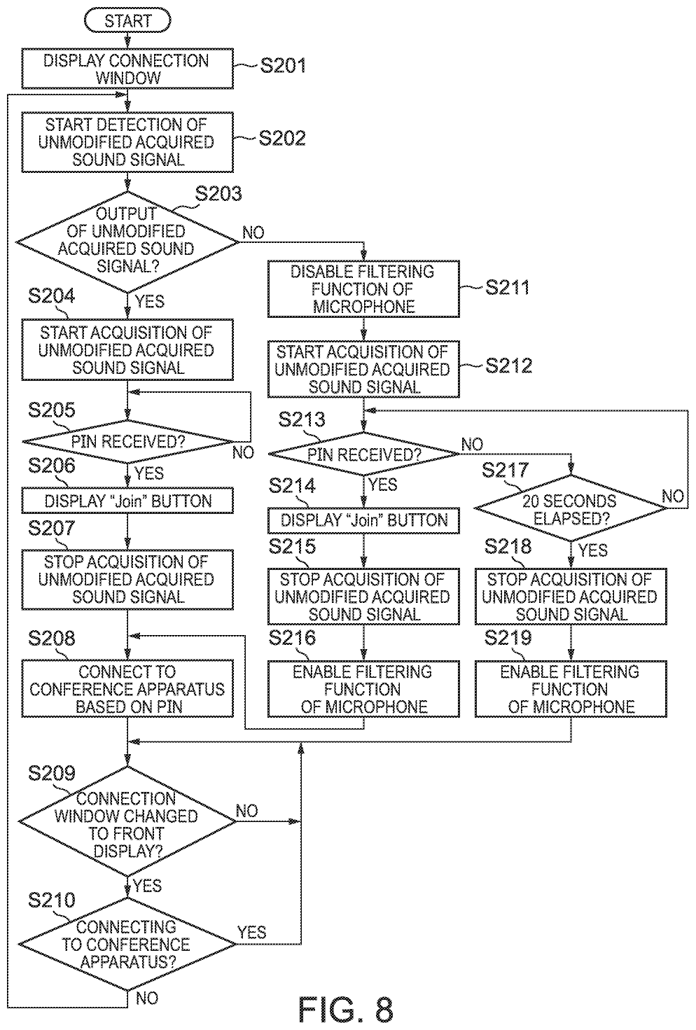

A detailed process by the terminal apparatus 4 in the above-described process in which the terminal apparatus 4 connects to the conference apparatus 1 will be described below, with reference to FIG. 8.

FIG. 8 is a flowchart illustrating an example of operation of the terminal apparatus 4 in this embodiment.

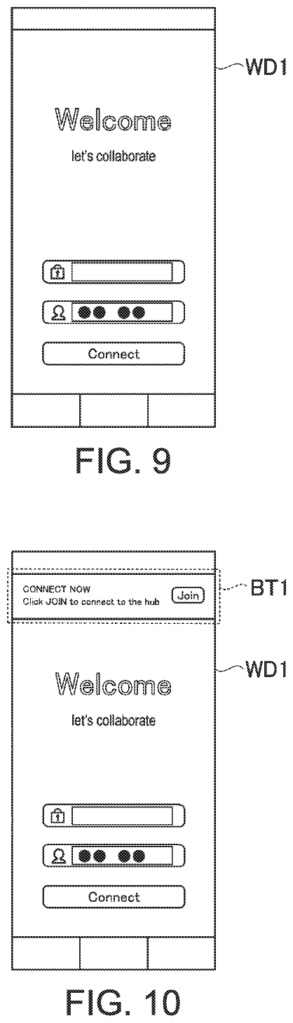

In FIG. 8, when the user executes a connection application, the terminal apparatus 4 first displays a connection window (step S201). The connection processing unit 451 causes the display processing unit 452 to display the connection window (e.g. window WD1 in FIG. 9) which is a display screen of the connection application, on the display unit 43.

FIGS. 9 to 11 each illustrate a display example in the connection process of the terminal apparatus 4 in this embodiment.

As illustrated in FIG. 9, the connection window WD1 includes a manual PIN input window as “Meeting ID”, a “Display name” input window, a “Connect” button, and the like.

Next, the connection processing unit 451 starts detection of an unmodified acquired sound signal (step S202). For example, the connection processing unit 451 causes the microphone 44 to start detection of an unmodified acquired sound signal. Herein, an unmodified acquired sound signal is a raw sound signal collected by the microphone 44, and is a sound signal not processed by a filtering function and the like.

The connection processing unit 451 then determines whether or not there is output of an unmodified acquired sound signal (step S203). The connection processing unit 451 determines whether or not a video system included in the terminal apparatus 4 has an output system capable of directly acquiring an unmodified acquired sound signal. In the case where there is output of an unmodified acquired sound signal (step S203: YES), the process advances to step S204. In the case where there is no output of an unmodified acquired sound signal (step S203: NO), the process advances to step S211.

In step S204, the connection processing unit 451 starts acquisition of a raw signal collected by the microphone 44.

The connection processing unit 451 then determines whether or not a PIN is received (step S205). The connection processing unit 451 determines whether or not a normal PIN is successfully extracted as a result of demodulating the frequency modulated sound wave of the unmodified acquired sound signal. In the case where the PIN is received (the normal PIN is successfully extracted) (step S205: YES), the process advances to step S206. In the case where the PIN is not received (the normal PIN is not successfully extracted) (step S205: NO), the process returns to step S205.

In step S206, the connection processing unit 451 displays a “Join” button BT1 (for example, see FIG. 10). In detail, the connection processing unit 451 causes the display processing unit 452 to display the “Join” button BT1 in the connection window WD1, as illustrated in FIG. 10.

After this, when the user clicks the “Join” button BT1, the connection processing unit 451 stops acquisition of an unmodified acquired sound signal (step S207).

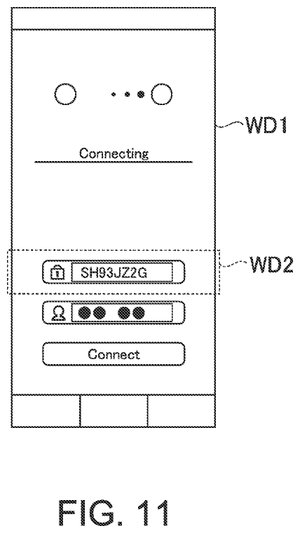

The connection processing unit 451 then connects to the conference apparatus 1 based on the PIN (step S208). The connection processing unit 451 connects to the conference apparatus 1 in the conference room MR1 by wireless LAN communication via the NW communication unit 41, using the extracted PIN. The connection processing unit 451 displays a connection window WD1 illustrated in FIG. 11, on the display unit 43.

In the connection window WD1 illustrated in FIG. 11, the PIN acquired from the conference apparatus 1 using the sound wave is displayed in a PIN input window WD2, and information indicating a connecting state (connecting) is displayed.

Next, the connection processing unit 451 determines whether or not the connection window WD1 is changed to the front display (step S209). The connection processing unit 451 determines whether or not the connection window WD1 is changed to the front in the display screen of the display unit 43 as a result of, for example, being designated by the user through the input unit 42. In the case where the connection window WD1 is changed to the front display (step S209: YES), the process advances to step S210. In the case where the connection window WD1 is not changed to the front display (step S209: NO), the process returns to step S209.

In step S210, the connection processing unit 451 determines whether or not the terminal apparatus 4 is being connected to the conference apparatus 1. In detail, the connection processing unit 451 determines whether or not the terminal apparatus 4 and the conference apparatus 1 are in a connecting state. In the case where the terminal apparatus 4 is being connected to the conference apparatus 1 (step S210: YES), the process returns to step S209. In the case where the terminal apparatus 4 is not being connected to the conference apparatus 1 (step S210: NO), the process returns to step S202.

In step S211, the connection processing unit 451 disables the filtering function of the microphone 44. In this case, the connection processing unit 451 disables the filtering function of the filter unit 453, because output of an unmodified acquired sound signal cannot be acquired directly.

Following this, the connection processing unit 451 starts acquisition of an unmodified acquired sound signal (step S212). As a result of disabling the filtering function of the filter unit 453, the connection processing unit 451 can acquire an unmodified acquired sound signal of a sound wave.

In step S213, the connection processing unit 451 determines whether or not a PIN is received, as in step S205. In the case where the PIN is received (the normal PIN is successfully extracted) (step S213: YES), the process advances to step S214. In the case where the PIN is not received (the normal PIN is not successfully extracted) (step S213: NO), the process advances to step S217.

The processes of steps S214 and S215 which follow are the same as the processes of steps S206 and S207 described above, and accordingly their description is omitted.

In step S216, the connection processing unit 451 enables the filtering function of the microphone 44. After the process of step S216, the process advances to step S208.

In step S217, the connection processing unit 451 determines whether or not 20 seconds have elapsed. In detail, the connection processing unit 451 determines whether or not 20 seconds as a predetermined period have elapsed from when the filtering function is stopped and acquisition of an unmodified acquired sound signal is started. In the case where 20 seconds have elapsed (step S217: YES), the process advances to step S218. In the case where 20 seconds have not elapsed (step S217: NO), the process returns to step S213.

The processes of steps S218 and S219 are the same as the processes of steps S215 and S216 described above, and accordingly their description is omitted. After the process of step S219, the process advances to step S208.

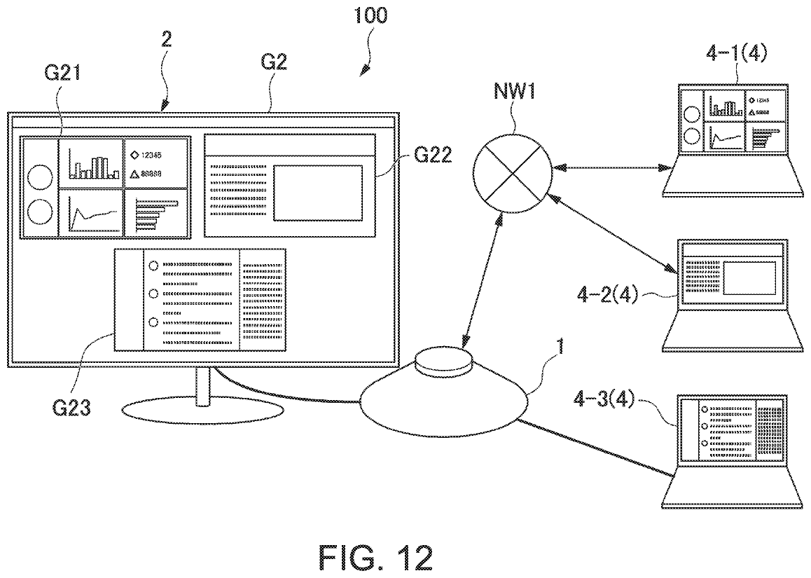

A display example in information sharing of the conference system 100 according to this embodiment will be described below, with reference to FIG. 12.

FIG. 12 is a diagram illustrating a display example in information sharing of the conference system 100 according to this embodiment

In the example in FIG. 12, the conference system 100 includes three terminal apparatuses 4 (4-1, 4-2, and 4-3).

The terminal apparatuses 4-1, 4-2, and 4-3 and the conference apparatus 1 are in the same conference room (e.g. the conference room MR1), and the terminal apparatuses 4-1 and 4-2 and the conference apparatus 1 are connected via the network NW1 using wireless communication. The terminal apparatus 4-3 is, for example, connected to the conference apparatus 1 by wired communication, via the video input/output unit 29 in the conference apparatus 1.

The conference apparatus 1 displays a screen acquired from each terminal apparatus 4, on a display screen G2 of the shared display apparatus 2. For example, in the display screen G2 of the shared display apparatus 2, a screen G21 corresponds to the screen displayed by the terminal apparatus 4-1, a screen G22 corresponds to the screen displayed by the terminal apparatus 4-2, and a screen G23 corresponds to the screen displayed by the terminal apparatus 4-3.

As described above, the conference system 100 according to this embodiment includes: the conference apparatus 1 (electronic apparatus) capable of outputting shared information; and the terminal apparatus 4. The conference apparatus 1 includes the sound wave speaker 27 (sound wave output unit) and the PIN output processing unit 531 (output processing unit). The sound wave speaker 27 outputs a sound wave. The PIN output processing unit 531 converts a PIN (apparatus identification information) for identifying the conference apparatus 1 into a sound wave, and outputs the sound wave from the sound wave speaker 27. The terminal apparatus 4 includes the microphone 44 (sound collection unit) and the connection processing unit 451. The microphone 44 collects the sound wave output from the sound wave speaker 27. The connection processing unit 451 extracts the PIN from a sound signal of the sound wave collected by the microphone 44, and connects the terminal apparatus 4 to the conference apparatus 1 by wireless communication based on the extracted PIN.

Thus, in the conference system 100 according to this embodiment, in the case of connecting the terminal apparatus 4 to the conference apparatus 1, the PIN necessary to designate the connection destination is transmitted from the conference apparatus 1 to the terminal apparatus 4 by sound wave. This eases the connection of the terminal apparatus 4, with there being no need to manually designate the connection destination to perform the connection. That is, in the conference system 100 according to this embodiment, the terminal apparatus 4 can be automatically connected to the conference apparatus 1.

Since sound (sound wave) does not pass through the walls of the conference room, transmitting the PIN to the terminal apparatus 4 using sound (sound wave) prevents, for example, a situation in which the terminal apparatus 4 erroneously receives a PIN of a conference apparatus 1 installed in an adjacent conference room as in the case of using wireless communication such as Bluetooth®. Therefore, in the conference system 100 according to this embodiment, erroneous connection such as connecting to a conference apparatus 1 in an adjacent conference room can be reduced.

In this embodiment, the conference system 100 further includes the shared display apparatus 2 that displays the shared information. The conference apparatus 1 further includes the voice speaker 26 (voice output unit) and the conference processing unit 532. The voice speaker 26 is provided independently of the sound wave speaker 27, and outputs sound in an audible range including voice. The conference processing unit 532 outputs, from the voice speaker 26, sound based on a sound signal acquired from the other-party apparatus 5 via the network NW1, and transmits information acquired from the terminal apparatus 4 to the other-party apparatus 5 via the network NW1 and displays the acquired information on the shared display apparatus 2 as the shared information.

Thus, in the conference system 100 according to this embodiment, the conference can be conducted using the other-party apparatus 5 via the network NW1. The conference system 100 according to this embodiment can therefore improve convenience.

In this embodiment, the conference processing unit 532 performs a filtering process of reducing a frequency region (e.g. a region of 18 kHz or more) of the sound wave on the sound signal acquired from the other-party apparatus 5, and outputs the resultant sound from the voice speaker 26.

Thus, in the conference system 100 according to this embodiment, an influence such as crosstalk or interference on the sound wave due to the sound of the sound signal acquired from the other-party apparatus 5 can be reduced, so that the terminal apparatus 4 can be connected to the conference apparatus 1 stably.

In this embodiment, the conference apparatus 1 includes a plurality of sound wave speakers 27 (e.g. two sound wave speakers 27). The plurality of sound wave speakers 27 are arranged at positions on a circumference so that the circumference is evenly divided by the plurality of sound wave speakers 27 (e.g. 180 degrees apart).

Thus, in the conference system 100 according to this embodiment, the sound wave can be output evenly in all directions of the conference apparatus 1, so that the terminal apparatus 4 can be connected to the conference apparatus 1 more stably.

In this embodiment, the sound wave is preferably in a range of 18 kHz to 20 kHz which are frequencies not perceived by the ear as sound.

Thus, in the conference system 100 according to this embodiment, a typical speaker and microphone for an audible range can be used as the sound wave speaker 27 and the microphone 44, and there is no need to use expensive sound wave speaker 27 and microphone 44 for ultrasound. This reduces component costs in the conference system 100 according to this embodiment. Moreover, in the conference system 100 according to this embodiment, a universal microphone 44 can be used, and there is no need to use special components (e.g. an ultrasonic microphone) as hardware of the terminal apparatus 4.

In this embodiment, the sound wave speaker 27 is a flat speaker.

Thus, in the conference system 100 according to this embodiment, the flat speaker can easily output a high frequency region (pseudo ultrasound region) in an audible range and can stably output a sound wave (pseudo ultrasound) at wide angle, as compared with a cone-type speaker.

In this embodiment, in the case where the terminal apparatus 4 includes the filter unit 453 for removing noise from the sound signal of the sound wave collected by the microphone 44, the connection processing unit 451 stops operation of the filter unit 453 for a predetermined period (e.g. 20 seconds) in which the microphone 44 collects the sound wave.

Thus, in the conference system 100 according to this embodiment, the risk that the terminal apparatus 4 cannot accurately receive (collect) the sound wave due to, for example, noise removal by the microphone 44 can be reduced.

In this embodiment, the conference apparatus 1 changes the PIN, in at least one of the case where the conference apparatus 1 is started or rebooted and the case where a new conference is started.

Thus, in the conference system 100 according to this embodiment, the PIN is changed each time, which enhances security.

In this embodiment, the PIN unique to the conference apparatus 1 is generated by the management server 6 that manages the conference apparatus 1. The conference apparatus 1 acquires the PIN from the management server.

Thus, in the conference system 100 according to this embodiment, for example, erroneous connection to a conference apparatus 1 in an adjacent conference room due to an overlap between PINs can be reduced.

In this embodiment, the sound wave speaker 27 is located at a higher position than the voice speaker 26.

Thus, in the conference system 100 according to this embodiment, the sound wave including the PIN can be output farther. Such a conference system 100 can cover a wide conference room.

The conference apparatus 1 (electronic apparatus) according to this embodiment includes the sound wave speaker 27 and the PIN output processing unit 531. The sound wave speaker 27 outputs a sound wave. The PIN output processing unit 531 converts a PIN (apparatus identification information) for identifying the conference apparatus 1 into a sound wave, and outputs the sound wave from the sound wave speaker 27. The conference apparatus 1 is connected with the terminal apparatus 4 (external apparatus) by wireless communication, based on the PIN extracted from a sound signal of the sound wave collected.

Thus, the conference apparatus 1 according to this embodiment has the same advantageous effects as the above-described conference system 100, and eases the connection of the terminal apparatus 4.

A connection method according to this embodiment is a connection method between the conference apparatus 1 (electronic apparatus) and the terminal apparatus 4 (external apparatus), and includes an output step and a connection step. In the output step, the conference apparatus 1 converts a PIN for identifying the conference apparatus 1 into a sound wave, and outputs the sound wave from the sound wave speaker 27. In the connection step, the terminal apparatus 4 extracts the PIN from a sound signal of the sound wave collected by the microphone 44 (sound collection unit), and connects to the conference apparatus 1 by wireless communication based on the extracted PIN.

Thus, the connection method according to this embodiment has the same advantageous effects as the above-described conference system 100 and conference apparatus 1, and eases the connection of the terminal apparatus 4.

The present invention is not limited to the foregoing embodiment, and modifications can be made without departing from the scope of the present invention.

For example, although the foregoing embodiment describes an example in which the management server 6 generates the PIN, the conference apparatus 1 may generate the PIN.

Although the foregoing embodiment describes the conference apparatus 1 as an example of an electronic apparatus, the present invention is not limited to such, and other electronic apparatuses may be used.

Although the foregoing embodiment describes an example in which the terminal apparatus 4 is a laptop PC, the terminal apparatus 4 may be any other terminal apparatus such as a PDA (Personal Digital Assistant).

Although the foregoing embodiment describes an example in which the sound wave is pseudo ultrasound including an audible range, the present invention is not limited to such, and the sound wave may be ultrasound outside an audible range.

Moreover, in the foregoing embodiment, the conference apparatus 1 may change the volume of the output sound wave depending on the size of the conference room.

Although the foregoing embodiment describes an example in which the shared display apparatus 2 is a liquid crystal display, the present invention is not limited to such, and the shared display apparatus 2 may be any other display apparatus such as a projector.

Each component in the foregoing conference system 100 includes a computer system. Processes in the components in the foregoing conference system 100 may be performed by recoding a program for implementing the functions of the components in the foregoing conference system 100 on a computer-readable recording medium and causing a computer system to read and execute the program recorded on the recording medium. Herein, “causing the computer system to read and execute the program recorded on the recording medium” includes installing the program in the computer system. The “computer system” herein includes an OS and hardware such as peripheral devices.

The “computer system” may include a plurality of computer apparatuses connected via the Internet, a WAN, a LAN, or a network including a communication line such as a dedicated line. The “computer-readable recording medium” refers to a portable medium such as a flexible disk, a magneto-optical disc, a ROM, or a CD-ROM, or a storage device such as a hard disk embedded in the computer system. Thus, the recording medium storing the program may be a non-transitory recording medium such as a CD-ROM.

The recording medium includes a recording medium internally or externally provided to be accessible from a distribution server for distributing the program. A configuration in which the program is divided into a plurality of parts and the components in the conference system 100 combine the parts after the parts are downloaded at different timings may be adopted, and distribution servers for distributing the parts into which the program is divided may be different. The “computer-readable recording medium” includes a medium that holds the program for a certain period of time, such as a volatile memory (RAM) inside a computer system serving as a server or a client when the program is transmitted via a network. The program may be a program for implementing some of the above-described functions. The program may be a differential file (differential program) that can implement the above-described functions in combination with a program already recorded in the computer system.

Some or all of the above-described functions may be implemented as an integrated circuit such as large scale integration (LSI). The above-described functions may be individually formed as a processor, or some or all thereof may be integrated into a processor. A method of forming an integrated circuit is not limited to LSI, and may be implemented by a dedicated circuit or a general-purpose processor. In the case where integrated circuit technology that can replace LSI emerges as a result of the advancement of semiconductor technology, an integrated circuit based on such technology may be used.

1. A conference system comprising:
an electronic apparatus configured to output shared information; and
a terminal apparatus,
wherein the electronic apparatus includes:
a sound wave output unit configured to output a sound wave; and
an output processing unit configured to convert apparatus identification information for identifying the electronic apparatus into the sound wave, and output the sound wave from the sound wave output unit, and
wherein the terminal apparatus includes:
a sound collection unit configured to collect the sound wave output from the sound wave output unit; and
a connection processing unit configured to extract the apparatus identification information from a sound signal of the sound wave collected by the sound collection unit, and connect the terminal apparatus to the electronic apparatus by wireless communication based on the extracted apparatus identification information.

2. The conference system according to claim 1, further comprising:
a shared display apparatus configured to display the shared information,
wherein the electronic apparatus further includes:
a voice output unit that is independent of the sound wave output unit, and configured to output sound in an audible range including voice; and
a conference processing unit configured to output, from the voice output unit, sound based on a sound signal acquired from an other-party apparatus via a network, and transmit information acquired from the terminal apparatus to the other-party apparatus via the network and display the acquired information on the shared display apparatus as the shared information.

3. The conference system according to claim 2, wherein the conference processing unit is configured to perform a filtering process of reducing a frequency region of the sound wave on the sound signal acquired from the other-party apparatus, and output the sound based on the sound signal subjected to the filtering process from the voice output unit.

4. The conference system according to claim 1, wherein the electronic apparatus includes a plurality of sound wave output units as the sound wave output unit, and
wherein the plurality of sound wave output units are arranged at positions on a circumference so that the circumference is evenly divided by the plurality of sound wave output units.

5. The conference system according to claim 1, wherein the sound wave is in a range of 18 kHz to 20 kHz which are frequencies not perceived by a human ear.

6. The conference system according to claim 1, wherein the sound wave output unit is a flat speaker.

7. The conference system according to claim 1, wherein the connection processing unit is configured to, in the case where the terminal apparatus includes at least a filter unit configured to remove noise from the sound signal of the sound wave collected by the sound collection unit, stop operation of the filter unit for a predetermined period in which the sound collection unit collects the sound wave.

8. The conference system according to claim 1, wherein the electronic apparatus is configured to change the apparatus identification information, in at least one case where the electronic apparatus is started or rebooted and a case where a new conference is started.

9. The conference system according to claim 1, wherein the apparatus identification information unique to the electronic apparatus is generated by a management server configured to manage the electronic apparatus, and
wherein the electronic apparatus is configured to acquire the apparatus identification information from the management server.

10. An electronic apparatus comprising:
a sound wave output unit configured to output a sound wave; and
an output processing unit configured to convert apparatus identification information for identifying the electronic apparatus into the sound wave, and output the sound wave from the sound wave output unit,
wherein the electronic apparatus is connected with an external apparatus by wireless communication based on the apparatus identification information extracted from a sound signal of the sound wave collected.

11. A connection method between an electronic apparatus and an external apparatus, the connection method comprising:
a step in which the electronic apparatus converts apparatus identification information for identifying the electronic apparatus into a sound wave, and outputs the sound wave from a sound wave output unit; and
a step in which the external apparatus extracts the apparatus identification information from a sound signal of the sound wave collected by a sound collection unit, and connects to the electronic apparatus by wireless communication based on the extracted apparatus identification information.
